(19) United States
(12) Patent Application Publication
(10) Pub. No.: US 2006/0215052 A1
(43) Pub. Date: Sep. 28, 2006

(54) Image recording and reproducing device and key assignment changing method

(75) Inventors: Shiro Nagaoka, Ome-shi (JP); Tatsuhiko Ikehata, Ome-shi (JP); Kei Tashiro, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/376,288

(22) Filed: Mar. 16, 2006

(30) Foreign Application Priority Data
Mar. 28, 2005 (JP) 2005-092774

(51) Int. Cl. H04N 5/222

(52) U.S. Cl. 348/333.06

(57) ABSTRACT

For use with an electronic camera including a display unit which is rotated through two axes perpendicular to each other and a key operating unit having different functions assigned to four directions of up, down, left and right, a key assignment changing method comprises detecting the rotation angle of the display unit, and changing the functions assigned to the key operating unit according to the detected rotation angle of the display unit.

### CROSS-REFERENCE TO RELATED APPLICATIONS

This application is based upon and claims the benefit of priority from Japanese Patent Application No. 2005-092774, filed Mar. 28, 2005, the entire contents of which are incorporated herein by reference.

### BACKGROUND

1. Field

The present invention relates to an image recording device, such as an electronic camera, which is equipped with a display unit adapted to display still or moving images and is rotatably mounted by means of a mechanism with one or more rotation axes, and with an operating unit for operating the displayed images, and an operating system.

2. Description of the Related Art

In general, electronic devices, such as portable video cameras, mobile phones, etc., have a display unit including a liquid crystal panel rotatably coupled to the main body equipped with various operating buttons. The user is thus allowed to perform an operation of opening or closing the display unit. An example of a portable information terminal equipped with such a rotatable display unit is disclosed in Japanese Patent Application KOKAI Publication No. 2004-40382. This information terminal is adapted to interchange the upper and lower sides as well as the right and left sides of an image displayed on the display unit according to the rotation angle of the display unit. Thereby, an image which looks natural from a directional viewpoint when viewed from the user can be displayed on the display unit at any rotation angle.

Some of the electronic devices equipped with a rotatable display unit have a rotating mechanism with two axes in directions perpendicular to each other. The display unit is opened in the first rotation direction and further rotated in the second rotation direction. Therefore, the display unit can be oriented in any desired direction.

With portable electronic devices having a two-axis rotating mechanism, it is also possible to use the display unit in a state where it is rotated to face in a direction opposite to the direction in which the user normally points it. However, in using the device with the display unit rotated to face in a direction different from the normal direction, the display unit and the operating unit may face in opposite directions.

In displaying a still image or moving images on the display unit, the user sets the device so that the image being displayed looks natural from a directional viewpoint. The top, bottom, left and right of the display screen are the top, bottom, left and right as viewed from the user. The user operates the operating unit with reference to the screen. For this reason, with devices equipped with a rotating display unit, it is desired that the functions assigned to an operating key on the operating unit can be changed to conform to the orientation of the display unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are perspective views of an electronic camera to which the principles of the invention is adapted;

FIG. 2 is a system block diagram of the electronic camera;

FIGS. 3A to 3C show the state of the electronic camera in which the display unit is housed in the main body;

FIGS. 4A and 4B show the state of the electronic camera in which the liquid crystal monitor is pointed to the lens side;

FIGS. 5A and 5B show the state of the electronic camera in which the display unit is further rotated from the normal position of FIG. 3C;

FIGS. 6A and 6B show the state of the electronic camera in which the display unit is further rotated from the normal position of FIG. 3C;

FIG. 7 shows the viewer position;

FIGS. 8A and 8B are diagrams for use in explanation of the difference in key assignment between the viewer position and the normal position;

FIGS. 9A to 9C show the orientation of the display unit by the two-axis rotating mechanism;

FIG. 10 is a flowchart illustrating the operation associated with key assignment at playback time according to the present invention; and

FIG. 11 is a flowchart illustrating the operation associated with key assignment at recording time according to the present invention.

### DETAILED DESCRIPTION

Various embodiments according to the invention will be described hereinafter with reference to the accompanying drawings. In general, according to one embodiment of the invention, according to an aspect of the present invention, there is provided an image recording and reproducing device comprising: an image capture unit which converts an optical image into an image consisting of an electrical signal; a display unit which displays the image captured by the image capture unit; a recording unit which has a recording medium and records the image captured by the image capture unit on the recording medium; a reproducing unit which reproduces the image recorded on the recording medium; an operating unit which is assigned a plurality of functions and, when one of the functions is selected, inputs operating instructions including instructions for the image capture unit, the recording unit, and the reproducing unit; a rotating mechanism having one or more axes for holding and rotating the display unit; a rotation angle detecting unit which detects the rotation angle of the display unit; and a function changing unit which changes the functions assigned to the operating unit according the rotation angle of the display unit detected by the angle detecting unit.

The function changing unit adapted to switch the functions assigned to the operating unit can be enabled or disabled by the user.

By switching the functions assigned to the operating unit to conform to the orientation of the display unit, it becomes possible to provide the user with an operating system that is always centered on the display unit.

The preferred embodiment of the present invention will be described hereinafter with reference to the accompanying drawings.

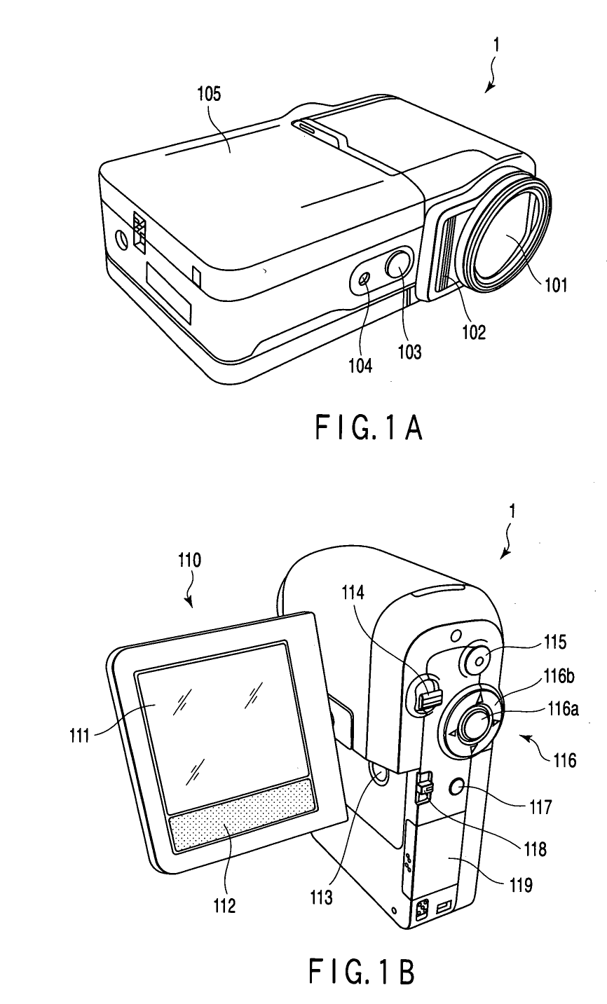

FIGS. 1A and 1B are perspective views of an electronic camera as an image recording device to which the principles of the invention are adapted. FIG. 1A is a perspective view of the electronic camera 1 from in front and below. Reference number 101 denotes a taking lens, 102 a flash, 103 a shutter button, 104 a remote control receiving unit, and 105 a battery cover.

FIG. 1B is a perspective view of the electronic camera 1 from behind and to the left. Reference number 111 denotes a liquid crystal monitor and 112 a loudspeaker, which are integrated into a display unit 110. The display unit 110, which is normally housed in a recess formed in the main body of the electronic camera 1, is opened when used as shown.

Reference number 115 denotes a movie recording button, which is operated when the user starts recording moving images. Reference number 114 is a zoom bar, which is used for a zoom operation. Reference numeral 116a denotes a cross key. The cross key 116a moves like a joystick. When the cross key is tilted in one of the directions indicated by the four arrows provided in the surface of a ring shaped member 116b, information concerning a direction or other information can be input to the device 1. When the cross key 116a is simply depressed, information concerning determination can be input to the device 1. The cross key 116a and the member 116b impressed with four arrows are referred hereinafter to as a cross key operating unit 116. Reference number 117 denotes a menu button, which is used to display various menus. An item in a menu is selected and determined by means of the cross key operating unit 116. Reference number 118 denotes a mode lever, which is used to switch between capture and playback modes. Reference number 119 denotes the cover of a slot into which a removable semiconductor memory card is loaded. Reference number 113 denotes a power on/off switch.

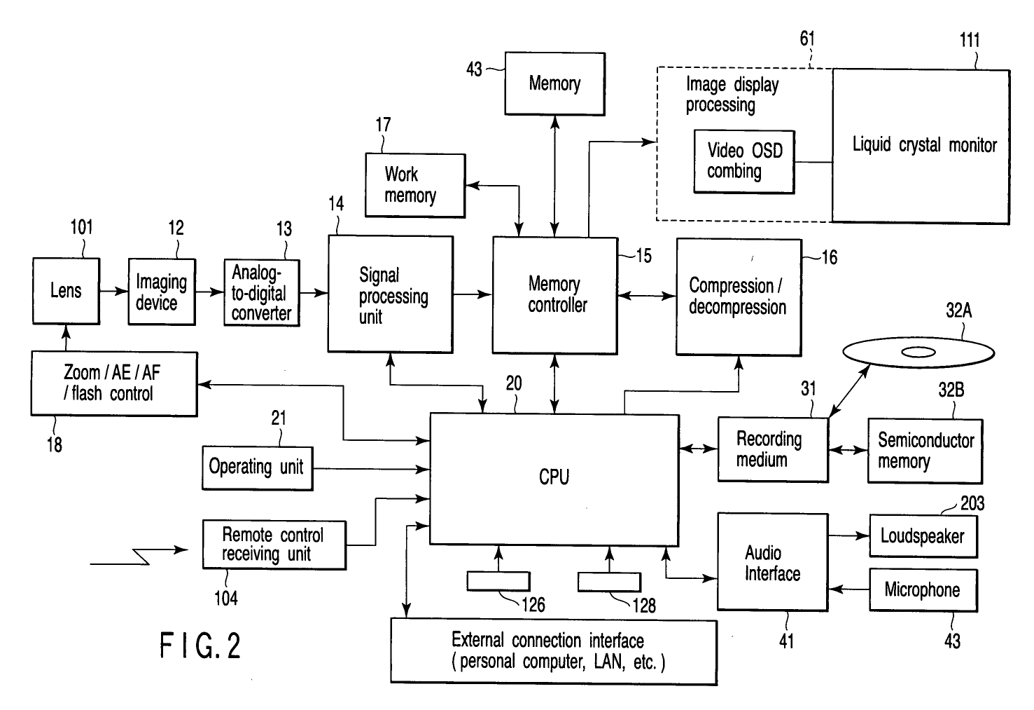

FIG. 2 is a system block diagram of the electronic camera 1. An image of a subject taken through a lens 101 is captured on an imaging device (for example, CCD) 12 and converted into an electrical signal. The resulting electric signal is converted into a digital signal by an analog-to-digital converter 13 and then fed into a signal processing unit 14, which provides gamma correction, color signal separation, white balance adjustment, etc. The imaging device 12, the analog-to-digital converter 13 and the signal processing unit 14 function as an image capture unit.

When no shutter operation is performed under normal shooting conditions, video data from the signal processing unit 14 is input through a memory controller 15 to an image display processing unit 61, which provides a conversion process for displaying a captured image on the liquid crystal monitor 111 and a menu combining process. Image data from the image display processing unit 61 is applied to the liquid crystal monitor 111. Thereby, an image being captured or a subject image on standby is displayed on the liquid crystal monitor 111.

When a shutter operation is performed, captured image data is compressed (for example, JPEG compressed) in an image compression/decompression unit 16 and then stored through a recording medium interface 31 into a hard disk 32A or a semiconductor memory (for example, SD memory card) 32B under the control of a central processing unit (CPU) 20. As an alternative to the hard disk or semiconductor memory, an optical disk may be used.

When image data is read from the recording medium, it is decompressed in the image compression/decompression unit 16 under the control of the CPU 20 and then input to the image display processing unit 61 through the memory controller 15. Thus, a reproduced image is displayed on the liquid crystal monitor 111.

A work memory 17 is used in editing image data, creating thumb nail images, or rearranging images. Further, it is also used in editing various icons. The work memory 17 is capable of storing one or more frames of image data. Image data stored in the work memory is input to the image display processing unit 61 through the memory controller 15, thus allowing the situation of image editing to be confirmed on the liquid crystal monitor 111.

At the time of image editing or capture, audio data can also be taken in through a microphone 43 and an audio interface 41 under the control of the CPU 20. The audio data is recorded on the recording medium together with captured image data. When playing back the recorded audio data, it is read from the recording medium simultaneously with the corresponding image data and then audibly output from the loudspeaker 112 through the audio interface 41 while at the same time the image is reproduced. It is also possible to eliminate sound in reproducing and confirming an image.

The CPU 20 is externally supplied with operating signals via an operation unit 21 or the remote control receiving unit 104. At the shooting time, the CPU 20 is responsive to operating signals to instruct a controller 18 to make zoom adjustment, automatic aperture (AE) adjustment, autofocus (AF) adjustment, flash control, etc. In addition, the CPU 20 is also connected to an external connection interface (not shown) to allow connection of the camera to an external display unit such as a TV set. Here, the operation unit 21 is composed of various operating buttons shown in FIG. 1. Reference numeral 126 denotes a switch that detects the opening or closing of the display unit 110 and 128 a sensor that detects the angle of rotation of the display unit 110.

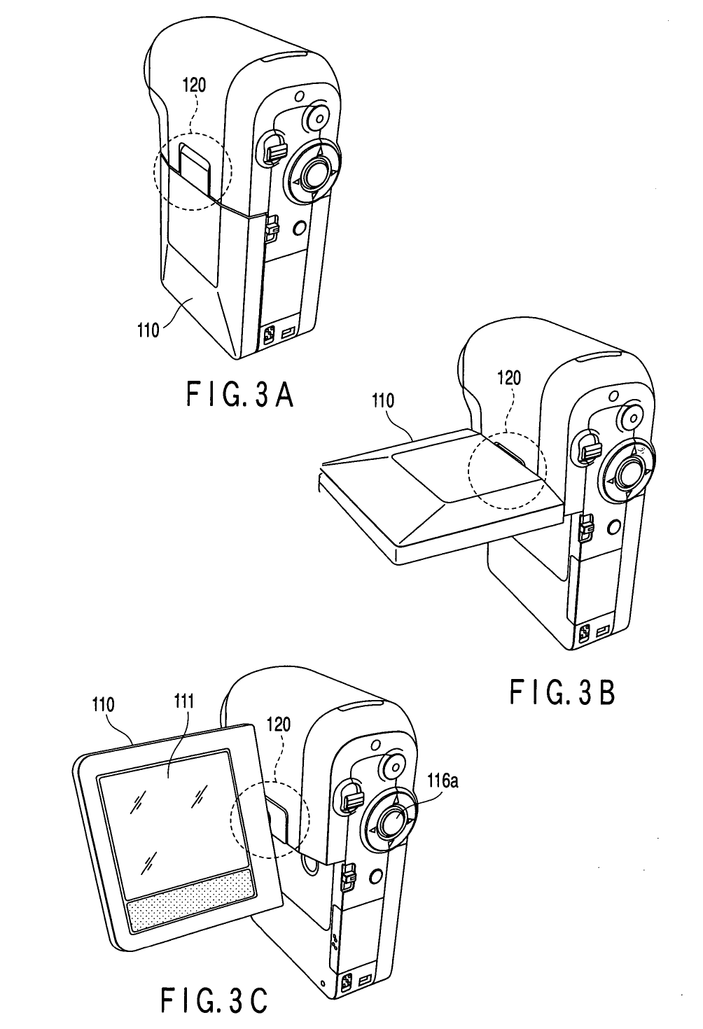

FIGS. 3 to 5 show various modes of use of the display unit 110 of the electronic camera of the present invention. By a rotating mechanism 120 having two axes which are perpendicular to each other, the display unit 110 can be rotated in two directions of rotation and held in any position.

FIG. 3A shows a state in which the display unit 110 is housed in the camera main body. In this state, the display unit cannot be viewed from the user and the camera power is off. Such a state in which the liquid crystal monitor 111 is closed inward and the camera power is off is referred herein as to the off position.

FIG. 3B shows a state in which the display unit 110 is opened from the off position shown in FIG. 3A by rotating the rotating mechanism 120. FIG. 3C shows a state in which the display unit 110 is rotated from the position of FIG. 3B using the rotating mechanism 120. In general, shooting is done in this state. Such a state in which the liquid crystal monitor 111 faces in the direction of the cross key 116a is referred herein to as the normal position.

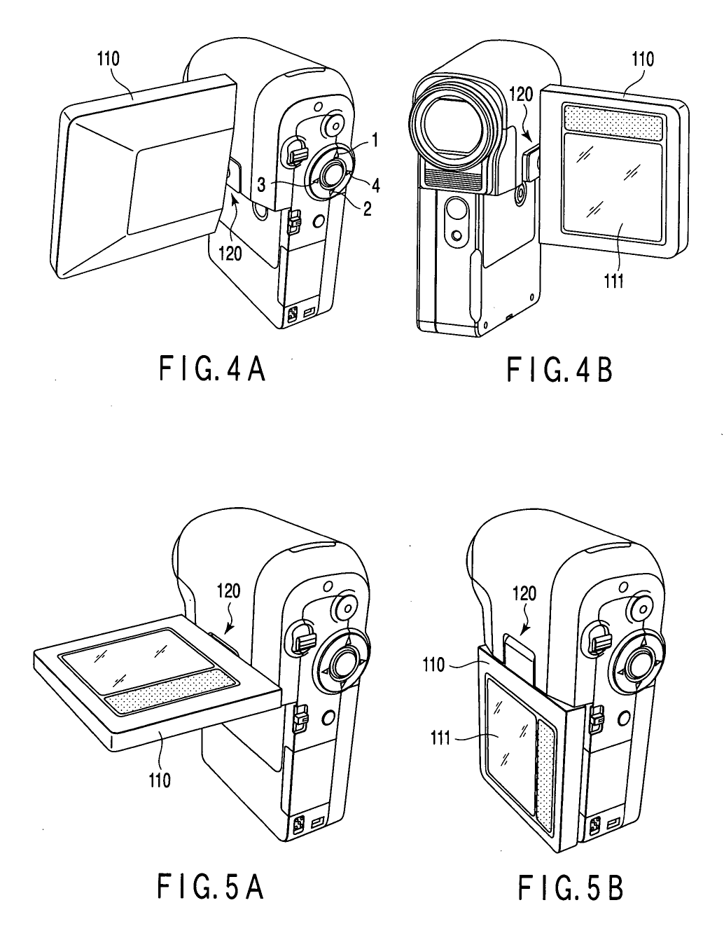

FIGS. 4A and 4B show a state in which the liquid crystal monitor 111 is turned to the lens side using the rotating mechanism 120. This state, which is referred herein as to the self-shooting position, is used when the user photographs himself or herself.

FIG. 5A shows a state in which the display unit 110 is further rotated from the normal position of FIG. 3C. The display unit 110 is rotated through 180 degrees with respect to the state of FIG. 3B.

FIG. 5B shows a state in which the display unit 110 is housed in the camera main body from the state of FIG. 5A. Such a state in which the liquid crystal monitor 111 is closed with its display surface facing outward is referred herein as to the viewer position. This viewer position is used, for example, when the camera is used as a reproducer.

As described above, with a device having a display unit coupled to its main body through one or more rotation axes, there are several modes of use and associated functional roles, depending on the position of the display unit.

For example, in the state of FIG. 3A, the display unit is housed in the main body and images cannot be viewed; therefore, in this mode of use of the camera it is appropriate to keep the camera power off. When the display unit 110 is opened by the user as shown in FIG. 3B, the user intends to use the camera; therefore, in this mode of use it is appropriate to turn the camera power on.

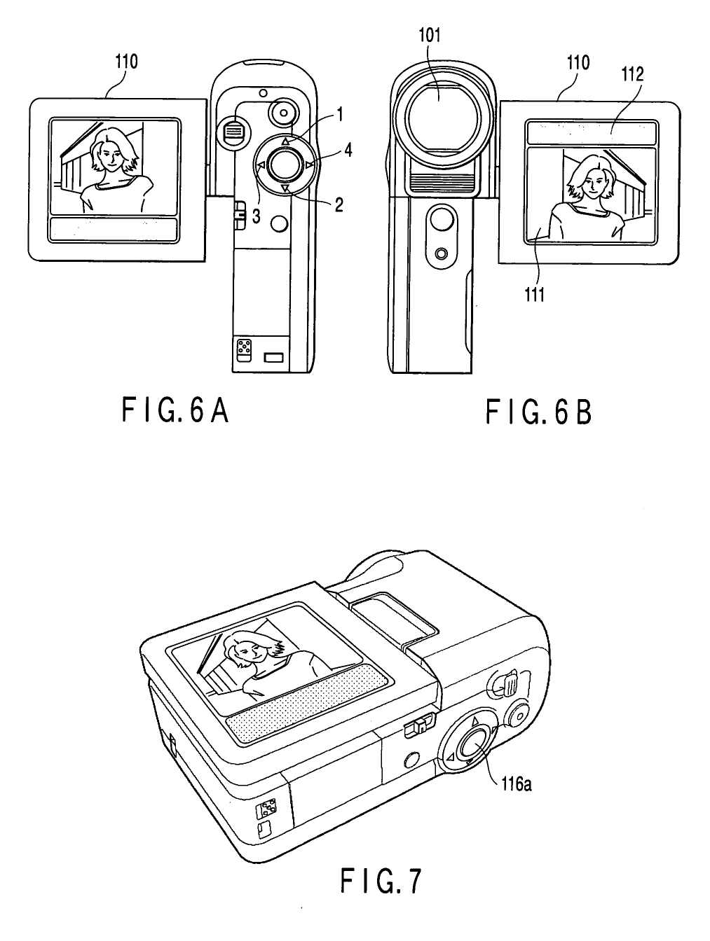

In the normal position of FIG. 3C and the self-shooting position of FIGS. 4A and 4B, the top and bottom sides as well as the right and left sides of a subject image displayed on the liquid crystal monitor 111 are interchanged as shown in FIGS. 6A and 6B. In FIG. 6B, since the lens and the liquid crystal monitor 111 face in the same direction (that is, the camera user photographs himself or herself), the right and left sides of the subject image are interchanged like a mirror image, allowing the user to perform operations without a feeling that something is wrong. Such right and left reverse display of a subject image on the liquid crystal monitor 111 is referred herein to as mirror display.

The key assignment according to the present invention will be described below.

The viewer position of FIG. 5B is one which is mainly used at playback time. Therefore, the user operates the camera with the main body oriented as shown in FIG. 7. In this embodiment, the normal position of FIG. 6A and the viewer position of FIG. 7 differ by 90 degrees in the function assignment to the four arrows indicating the directions to operate the cross key 116a (key assignment).

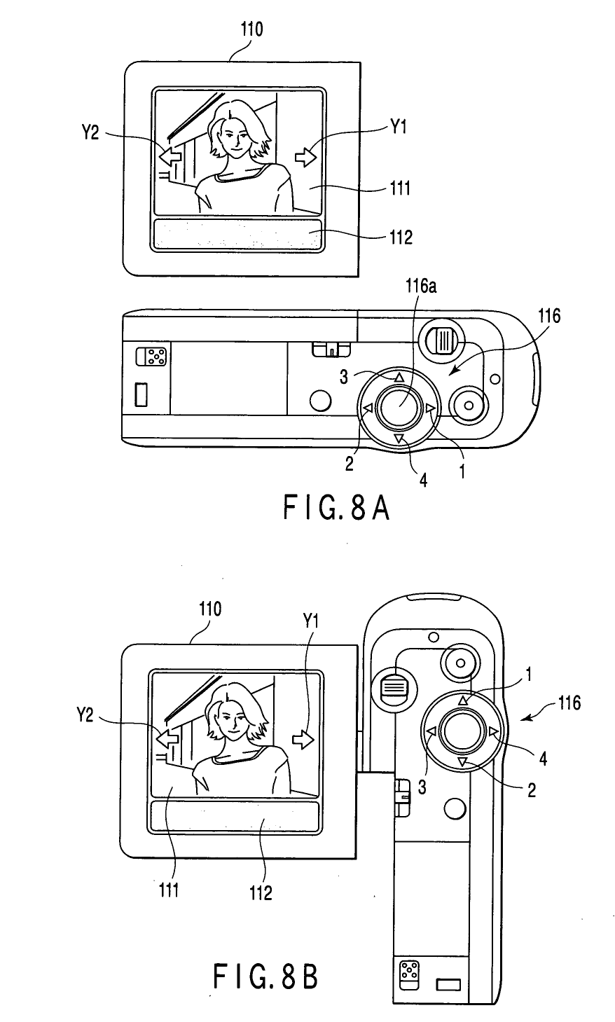

FIGS. 8A and 8B are diagrams for use in explanation of the difference in key assignment between the viewer position and the normal position.

For example, in the case of still image reproduction, right- and left-pointing arrows Y1 and Y2 are displayed on the liquid crystal monitor 111. These arrows indicate directions in which image display is changed. In the viewer position of FIG. 8A, the arrow Y1 in the displayed image and an arrow 1 of the cross key operating unit 116 coincide with each other in direction and function. That is, when the cross key 116a is tilted in the direction of the arrow 1 (to the right), the next image is displayed on the liquid crystal monitor 111. On the other hand, when the cross key 116a is tilted in the direction of the arrow 2 (to the left), the preceding image is displayed on the liquid crystal monitor 111.

In the normal position of FIG. 8B, in order to make the arrows Y1 and Y2 in the displayed image and the arrows of the cross key operating unit 116 coincident in direction and function, the function of next image display is assigned to the arrow 4 and the function of preceding image display is assigned to the arrow 3. That is, in this embodiment, the key assignment of the cross key operating unit 116 in the normal position of FIG. 8B is displaced by 90 degrees in a clockwise direction from that in the viewer position of FIG. 8A to conform to the orientation of the display unit 110 (liquid crystal monitor 111).

When the user operates the camera in the state where the lens 101 and the liquid crystal monitor 111 face in the same direction as shown in FIG. 6B, the key assignment of the cross key operating unit 116 is reversed in left and right from that in the normal position of FIG. 6A.

Thus, the present invention automatically changes the functions assigned to the keys in accordance with the orientation (angle of rotation) of the display unit 110. In order to automatically change the functions assigned to the keys according to the orientation of the display unit, it is required to detect in which direction the display unit 110 is set to face.

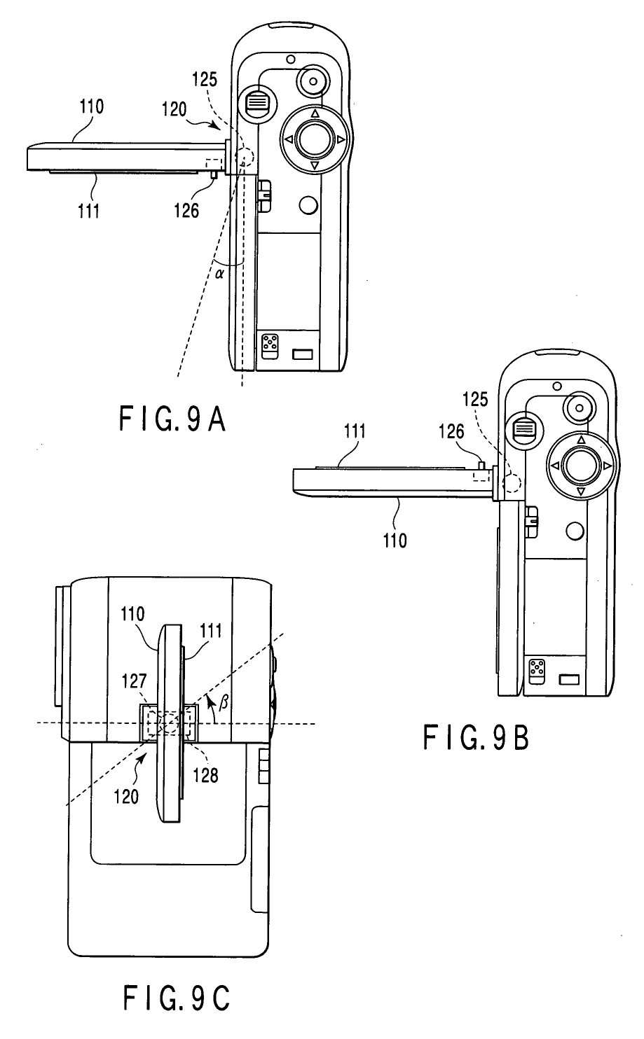

FIGS. 9A to 9C show the orientations of the display unit 110 rotated by the two-axis rotating mechanism 120.

FIG. 9A shows motion by a first rotation axis 125 of the two-axis rotating mechanism 120. In this state, the display unit 110 is oriented downward as shown. Here, the orientation of the display unit 110 indicates the direction in which the liquid crystal monitor 111 built in the display unit 110 faces. In this state, if the rotation axis 125 is rotated by an angle of more than a, the power is turned on. If, on the other hand, the rotation angle is less than α, the power is kept off. The rotation angle α is detected by the switch 126 provided in the display unit 110.

FIG. 9B shows motion by the first rotation axis 125 like FIG. 9A but differs in that the display unit 110 faces upward. Rotation of a second rotation axis 127 in the state of FIG. 9A causes the display unit 110 to go to the state of FIG. 9B through the state of FIG. 9C. Thus, the operation of the second rotation axis 127 is required. The rotation angle of the second rotation axis 127 is detected by an angle sensor 128 built in the two-axis rotating mechanism 120. In this case, key assignment and positions are determined according to the rotation angle β of the second rotation axis 127. For example, when the rotation angle β lies in the range of 0 to 175°, the position is decided to be the normal position. In the range of 175 to 185°, the position is decided to be the viewer position. In the range of 185 to 360°, the position is decided to be the self-shooting position.

The operation of the electronic camera associated with key assignment will be described next.

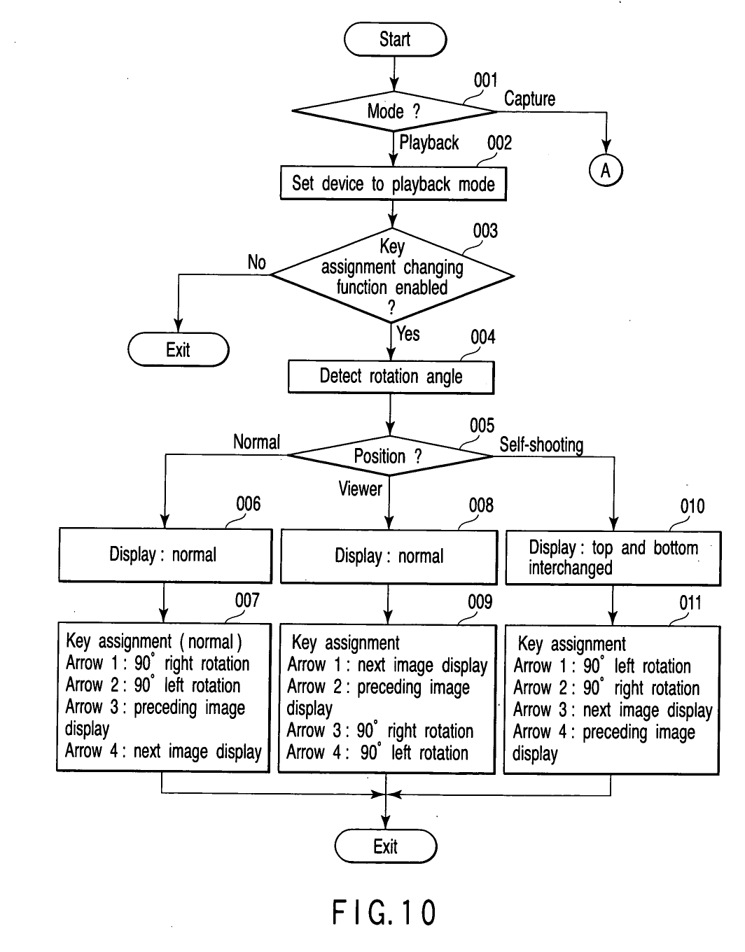

FIG. 10 is a flowchart illustrating the operation associated with key assignment at playback time according to the present invention. The modes of the electronic camera comprise the shooting mode and the playback mode. Mode switching can be done by operating the mode lever 118.

In block 001, the CPU 20 determines the mode of the device according to the current state of the mode lever 118. When the mode lever 118 is slid downward, the shooting mode is selected. When the mode lever 118 is slid upward, the playback mode is selected. When the playback mode is selected, the CPU 20 sets the camera to the playback mode (block 002) and then decides whether the key assignment change function has been set effective (available) (block 003). For example, this decision is made by referring to user set information recorded in the nonvolatile memory 43. That is, the device allows the user to enable or disable the key assignment change function.

The CPU 20 detects the rotation angle of the display unit 110 using the rotation angle sensor 128 in the two-axis rotating mechanism 20 (block 004) and then decides the device position according to the detected rotation angle (block 005).

If the device position is the normal position, then the CPU 20 makes a normal display of the last captured still image on the liquid crystal monitor 111 (block 006). In the normal display, the speaker 112 is located literally below the displayed image as shown in FIG. 8A or 8B.

The CPU 20 next sets the normal key assignment corresponding to the normal position (block 007). In the normal key assignment in the normal position of FIG. 8B, as shown in block 007, the arrows 1, 2, 3 and 4 are assigned “90° RIGHT ROTATION”, “90° LEFT ROTATION”, “PRECEDING IMAGE DISPLAY”, and “NEXT IMAGE DISPLAY”, respectively.

If the device position is the viewer position, then the CPU 20 makes a normal display of a still image as in the case of the normal position (block 008).

The CPU 20 next sets the key assignment corresponding to the viewer position, i.e., the key assignment resulting from rotating the normal key assignment left by 90° on the operating unit 116 (block 009). In this key assignment in the viewer position of FIG. 8A, as shown in block 009, the arrows 1, 2, 3 and 4 are assigned “NEXT IMAGE DISPLAY”, “PRECEDING IMAGE DISPLAY”, “90° RIGHT ROTATION” and, “90° LEFT ROTATION”, respectively.

If the device position is the self-shooting position, then the CPU 20 displays the still image in the normal position so that its top and bottom sides are interchanged (block 010). As a result, the image is displayed on the liquid crystal monitor 111 with the loudspeaker 112 located literally above the displayed image.

The CPU 20 next sets the key assignment corresponding to the self-shooting position, i.e., the key assignment in which right and left on the operating unit 115 in the normal key assignment are interchanged (block 011). In this key assignment in the self-shooting position of FIG. 4, as shown in block 011, the arrows 1, 2, 3 and 4 are assigned “90° RIGHT ROTATION”, “90° LEFT ROTATION”, “NEXT IMAGE DISPLAY”, and “PRECEDING IMAGE DISPLAY”, respectively.

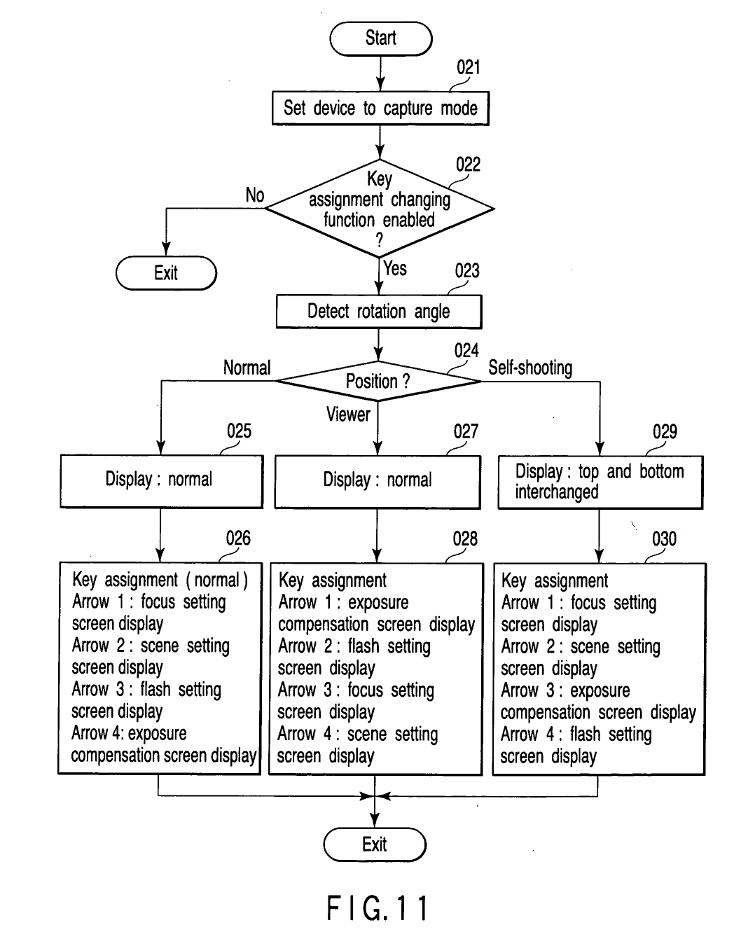

The key assignment in the shooting mode will be described next. FIG. 11 is a flowchart illustrating the operation associated with key assignment in the shooting mode.

When the shooting mode is selected, the CPU 20 sets the device to the shooting mode (block 021) and then detects the rotation angle of the display unit 110 using the rotation angle sensor 128 in the two-axis rotating mechanism 20 (block 023). The CPU 20 decides the device position according to the detected rotation angle (block 024).

If the device position is the normal position, then the CPU 20 normally displays an image being captured through the taking lens 101 on the liquid crystal monitor 111 as shown in FIG. 8B (block 006).

The CPU 20 next sets the normal key assignment corresponding to the normal position at shooting time (block 026). In this normal key assignment in the normal position of FIG. 8B, as shown in block 026, the arrows 1, 2, 3 and 4 are assigned “FOCUS SETTING SCREEN DISPLAY”, “SCENE SETTING SCREEN DISPLAY”, “FLASH SETTING SCREEN DISPLAY”, and “EXPOSURE COMPENSATION SCREEN DISPLAY”, respectively. For example, when the cross key 116a is tilted toward the arrow 1, the focus setting screen is displayed on the liquid crystal monitor 111.

The focusing modes include autofocusing mode, manual infinity focusing mode suitable for shooting a subject at a distance of about 5 m or more from the camera, etc. The scene modes include landscape mode suitable for shooting distant scenes, landscapes, etc., night scene mode suitable for shooting fireworks and night scenes, etc. The flash modes include autoflash mode in which a flash of light is automatically produced according to shooting conditions, forced flash mode in which a flash of light is always produced, etc. The exposure compensation can be made from −2.0 to +2.0in 1/3 EV increments.

In the viewer position, the display is set to the normal display as in the case of playback (block 027). The key assignment is set such that the normal key assignment is rotated left by 90° on the operating unit 116 (block 028). That is, in the viewer position, as shown in block 028, the arrows 1, 2, 3 and 4 are assigned “EXPOSURE COMPENSATION SCREEN DISPLAY”, “FLASH SETTING SCREEN DISPLAY”, “FOCUS SETTING SCREEN DISPLAY”, and “SCENE SETTING SCREEN DISPLAY”, respectively.

In the self-shooting position, the subject image is displayed so that up and down as well as right and left are interchanged (block 029). Thereby, an image as if the user is reflected in a mirror is displayed on the liquid crystal monitor 111 (mirror display shown in FIG. 6B). The key assignment is set such that right and right on the operating unit 116 in the normal key assignment are interchanged (block 030).

That is, in the self-shooting position, as shown in block 030, the arrows 1, 2, 3 and 4 are assigned “FOCUS SETTING SCREEN DISPLAY”, “SCENE SETTING SCREEN DISPLAY”, “EXPOSURE COMPENSATION SCREEN DISPLAY”, and “FLASH SETTING SCREEN DISPLAY”, respectively.

According to the electronic camera of the present invention described above, arrows pointing to the same direction in any of the positions described above are assigned the same function, thus significantly improving the operability of the device in comparison with conventional devices.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image recording and reproducing device comprising:
an image capture unit which converts an optical image into an image consisting of an electrical signal;
a display unit which displays the image captured by the image capture unit;
a recording unit which has a recording medium and records the image captured by the image capture unit on the recording medium;
a reproducing unit which reproduces the image recorded on the recording medium;
an operating unit which is assigned a plurality of functions and, when one of the functions is selected, inputs operating instructions including instructions for the image capture unit, the recording unit, and the reproducing unit;
a rotating mechanism having one or more axes for holding and rotating the display unit;
a rotation angle detecting unit which detects the rotation angle of the display unit; and
a function changing unit which changes the functions assigned to the operating unit according the rotation angle of the display unit detected by the angle detecting unit.

2. The image recording and reproducing device according to claim 1, further comprising a switching unit which selectively enables or disables the function of the function changing unit.

3. The image recording and reproducing device according to claim 1, wherein the operating unit is equipped with an operating key assigned different functions for operations in four directions of up, down, left and right.

4. The image recording and reproducing device according to claim 3, wherein, of the functions assigned to the operating key, the functions assigned for operations in two directions of left and right are interchanged according to the rotation angle of the display unit detected by the rotation angle detecting unit.

5. The image recording and reproducing device according to claim 3, wherein the function changing unit changes each of the directions of the operations for the functions by 90° according to the rotation angle detected by the rotation angle detecting unit.

6. The image recording and reproducing device according to claim 1, wherein the function changing unit includes a unit adapted to interchange the top and bottom sides of an image to be displayed on the display unit according to the rotation angle detected by the rotation angle detecting unit.

7. The image recording and reproducing device according to claim 1, wherein the function changing unit includes a unit adapted to interchange the top and bottom sides as well as the left and right sides of an image to be displayed on the display unit according to the rotation angle detected by the rotation angle detecting unit.

8. A key assignment changing method for use with an electronic camera including a display unit which is rotated through two axes perpendicular to each other and a key operating unit having different functions assigned for four directions of up, down, left and right, comprising:
detecting the rotation angle of the display unit; and
changing the functions assigned to the key operating unit according to the detected rotation angle of the display unit.

9. The key assignment changing method according to claim 8, wherein the changing includes changing each of the directions of the operations for the functions by 90° according to the detected rotation angle of the display unit.

10. The key assignment changing method according to claim 8, wherein, of the functions assigned to the operating key, the functions assigned for operations of two directions of left and right are interchanged according to the detected rotation angle of the display unit.
